(19) United States
(12) Patent Application Publication
(10) Pub. No.: US 2007/0143336 A1
(43) Pub. Date: Jun. 21, 2007

(54) Systems and methods for position management

(76) Inventors: Gail Marie Lindley, Henry, IL (US); Julie Anne Jones, Peoria Heights, IL (US); Sheila Ann Winchester, Bartonville, IL (US); Betty Jane Lehman, Peoria, IL (US); Beverly Ann Derby, Chillicothe, IL (US); Gregory Vincent Pilon, East Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/312,484

(22) Filed: Dec. 21, 2005

(51) Int. Cl. G06F 7/00

(52) U.S. Cl. 707/102

(57) ABSTRACT

Methods and systems for position management are disclosed. In one embodiment, a system for providing position management may include a community of position management including members and a position management system. The position management system may be configured to create an organization chart with one or more employment positions associated with an organization, receive a request to change an employment position in the organization, notify one or more members in the community to approve the requested change, and generate an updated organization chart reflecting the requested change of the employment position.

### TECHNICAL FIELD

The present disclosure relates to a system for managing human resources, and more particularly, to a system that manages human resources by managing positions in a business organization whether the positions are filled or vacant.

### BACKGROUND

Most organizations have formalized human resource management functions such as selection, evaluation, and payroll processes. Efficient and effective management of the human capital pool has become an increasingly imperative and complex activity to all organizations. The human resource management function consists of tracking innumerable data points on each staff member, from personal histories, data, skills, capabilities, experiences to payroll records. To reduce the manual workload of these administrative activities, organizations electronically automate many of these processes by introducing innovative human resource management systems.

Human resource management systems help organizations to specify, execute, monitor, and coordinate the flow of work cases within a distributed office environment. Such a system usually contains two basic components. A first component is the a workflow modeling component, which is also known as a specification module or a build time system. The workflow modeling component enables administrations and analysts to define, analyze, and simulate processes and activities, and assign them to people. The second component is a workflow execution component, which is also referred to as a run-time system. It consists of an execution interface used by end-users and the workflow engine, and an execution environment that coordinates and performs the processes and activities.

Position management is a concept of position ownership by departments or business units. Instead of focusing on tracking employees, position management systems allow better tracking and managing of positions in an organization. Position management systems may be implemented through human resource web tools and aim to enable managers to create and fill new positions, reclassify existing positions, reclassify and fill existing positions, delete positions, and reorganize positions.

Although conventional human resource management systems and position management systems described above improve efficiency of human resource management, these systems have several disadvantages. For example, in conventional systems, when an employee left a position, that position may be removed along with the employee, and the position's funding “disappears” into other department budgets. That is, conventional systems cannot provide comprehensive headcount and roster of staff members that may be used to fully evaluate the financial performance of an organization. Further, conventional systems do not track vacancies and hiring activities for future personnel planning, nor do they provide real time organization charts that reflect the most current status of positions in an organization.

Methods and systems consistent with certain disclosed embodiments may solve one or more of the problems set forth above.

### SUMMARY OF THE INVENTION

It is to be understood that both the foregoing general description and the following detailed description are exemplary and explanatory only and are not restrictive of the invention as claimed.

Methods and systems of position management are disclosed. In one embodiment, a system for providing position management may include a community of position management including members and a position management system. The position management system may be configured to create an organization chart with one or more employment positions associated with an organization, receive a request to change an employment position in the organization, notify one or more members in the community to approve the requested change, and generate an updated organization chart reflecting the requested change of the employment position.

The position management system may also be configured to create an organization chart with one or more employment positions associated with an organization, receive a request to vacate an employment position in the organization chart, notify members in the community to approve the vacate request, and generate an updated organization chart reflecting the vacate request of the employment position.

### BRIEF DESCRIPTION OF THE DRAWINGS

The accompanying drawings, which are incorporated in and constitute a part of this specification, illustrate exemplary embodiments of the invention and together with the description, serve to explain the principles of the invention. In the drawings:

FIG. 1 is a block diagram of an exemplary community of position management consistent with certain embodiments of the present invention;

FIG. 2 is a block diagram of an exemplary position management architecture consistent with certain embodiments of the present invention;

FIG. 3 is a flow chart illustrating an exemplary process to create an organization chart consistent with certain embodiments of the present invention;

FIG. 4 is a flow chart illustrating an exemplary process to add a position in an organization chart consistent with certain embodiments of the present invention;

FIG. 5 provides two exemplary organization charts consistent with certain embodiments of the present invention;

FIG. 6 is a flow chart illustrating an exemplary process to change a position in an organization chart consistent with certain embodiments of the present invention;

FIG. 7 is a flow chart illustrating an exemplary process to delete a position in an organization chart consistent with certain embodiments of the present invention;

FIG. 8 is a flow chart illustrating an exemplary process to fill a position in an organization chart consistent with certain embodiments of the present invention; and

FIG. 9 provides two exemplary organization charts consistent with certain embodiments of the present invention.

### DETAILED DESCRIPTION

Reference will now be made in detail to embodiments of the invention, examples of which are illustrated in the accompanying drawings. Wherever possible, the same reference numbers will be used throughout the drawings to refer to the same or like parts.

Methods and systems consistent with the disclosed embodiments may relate to an organization. An organization may be a group of people with common goals. An organization may be a business entity that includes a group of employees working in various employment positions. An organization has the authority and responsibility to establish, classify, and manage its employment positions. A position refers to a job function served by a staff member in an organization. A staff member may be an employee, a contract worker, an agent working for the organization, etc.

One way to manage positions in an organization is to associate a position to a business case or a budget. This helps an organization maintain information on every authorized employment position and budget committed to that position, regardless of whether the position is filled or vacant. It also allows the organization to track positions in addition to tracking its employees. Another way to manage positions in an organization is to use organization charts that reflect the most current organization structure. An organization chart is a diagram representative of the hierarchy of an organization's employment positions. An organization chart may define responsibilities within an organization.

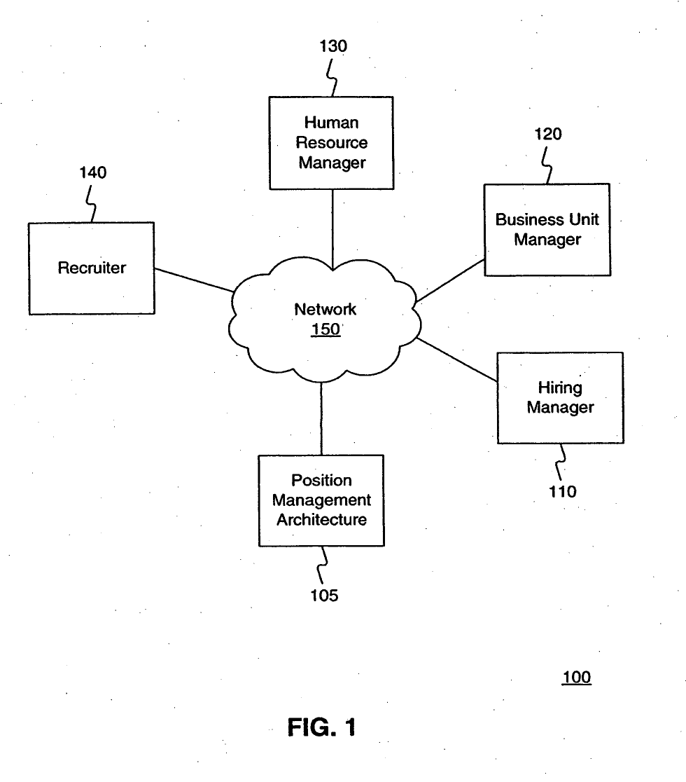

FIG. 1 illustrates an exemplary community of position management 100 consistent with certain embodiments of the present invention. As shown in FIG. 1, community of position management 100 includes a position management architecture 105, a hiring manager 110, a business unit manager 120, a human resource manager 130, a recruiter 140, and a network 150.

Position management architecture 105 may facilitate interaction among the members (e.g., hiring manager 110, business unit manager 120, human resource manger 130, and recruiter 140) in community of position management 100. Position management architecture 105 may also generate, maintain, update, delete, and present human resource records, such as position data records, and position change entries. A position data record may include all data related to the definition and processes of a employment position in position management architecture 105.

Hiring manager 110, business unit manager 120, human resource manager 130, and recruiter 140 may be persons performing corresponding position management functions in community of position management 100. Hiring manager 110, business unit manager 120, human resource manager 130, and recruiter 140 may also represent computer systems or software applications executed by processors configured to perform their corresponding functions in community of position management 100. These computer systems may each include a memory, a processor, and a display for presenting one or more maps, graphs, messages, etc., consistent with certain disclosed embodiments of position management architecture 105.

Hiring manager 110 may interact with business unit manager 120, human resource manger 130, or recruiter 140 via network 150, for example, by posing inquiries or responding to the inquiries of others. Hiring manager 110 may also access position data records or position change entries via position management architecture 105. Further, hiring manager 110 may submit his own inquires and position management requests to position management architecture 105. A position management request refers to any requests or inquiries made by a member of community of position management 100 when performing position management functions. Position management requests include requests to add, change, delete a position in an organization, etc. Hiring manager 110 may interface with community of position management 100 using personal computers, work stations, or other devices connected to network 150. Although only one hiring manager 110 is illustrated in FIG. 1, community of position management 100 may include a plurality of hiring managers.

Business unit manager 120 is similar to hiring manager 110, but may have the authority to approve position management requests submitted by hiring manager 110, and to approve a new organization chart or a modification to an organization chart. Although only one business unit manager 120 is illustrated in FIG. 1, community of position management 100 may include a plurality of business unit managers.

Human resource manager 130 may function as the facilitator for community of position management 100. Human resource manager 130 may be responsible for review, validation, auditing, and updating the information in position management architecture 105. Community of human management 100 may include one or more human resource managers.

Recruiter 140 is similar to human resource manager 130, but may have the responsibility for receiving job posting information, posting jobs, and identifying candidates to fill positions in an organization. Community of human management 100 may include one or more recruiters.

Network 150 may be the Internet, a wireless local area network (LAN), or any other type of network. Thus, network 150 may be any type of communications system.

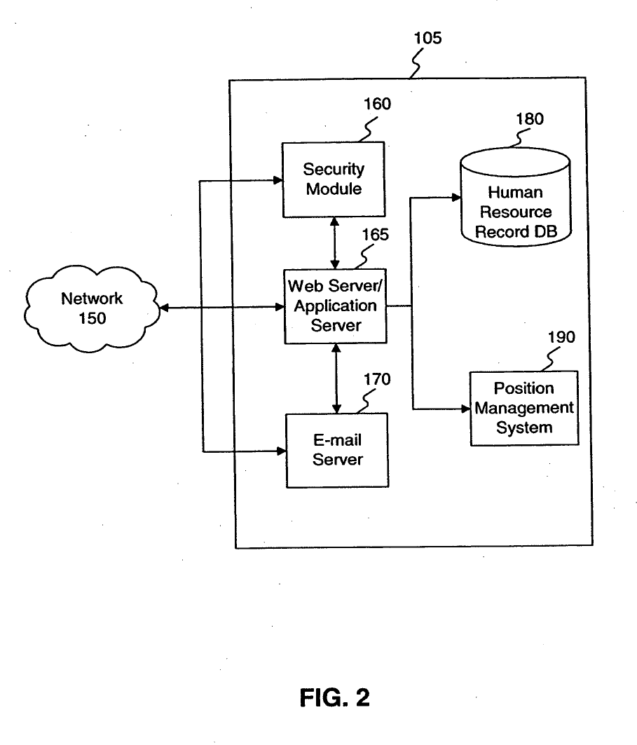

FIG. 2 is a block diagram illustrating an exemplary position management architecture 105. Position management architecture 105 may include a security module 160, a Web server/application host module 165, an e-mail server 170, a human resource record database 180, and a position management system 190. Security module 160, Web server module 165, and e-mail server 170 interface with network 150. Web server module 165 is connected to e-mail server 170. Web server module 165 is also connected to human resource record database 180 and position management system 190. It is contemplated that a position management architecture of the present invention may include some or all of the components of FIG. 2.

Security module 160 may be a computer system or software executed by a processor that is configured to determine what type of access each member in community of position management 100 has with respect to human resource record database 180 and/or the position management system 190. For example, recruiter 140 may be authorized to access records in human resource record database 180 but not alter the records. Human resource manager 130 and/or hiring manager 110, on the other hand, may be permitted access to human resource database 180, as well as the ability to alter human resource record database 180. Further, security module 160 may be used to permit different levels of access to different users, based on, for example, user's role in an organization. For example, hiring manager 110 may be permitted access to only a portion of human resource record database 180, whereas human resource manager 130 may access the entire human resource record database 180.

Web server/application host module 165 may include an interface for entities to access human resource record database 180, as well as position management system 190. Further, web server module 165 may include additional capabilities, such as collaboration tools to permit entities in community of position management 100 to work together, bulletin boards to permit entities in community of position management 100 to communicate with each other, and/or search engines to provide efficient access to specific entries in human resource record database 180 or position management system 190. Web server module 165 may also permit entities in community of position management 100 to submit records to be added to human resource record database 180. An exemplary web server application is Apache HTTP Server from the Apache Software Foundation.

E-mail server 170 may be a computer system or software executed by a processor that is configured to provide hiring manager 110, business unit manager 120, human resource manager 130, and recruiter 140 with current information from position management architecture 105. For example, when a new organization chart has been approved, position management system 190 may trigger e-mail server 170 to forward the new organization chart to members in the community of position management 100. An organization chart may be a diagram representing the hierarchy of an organization's employment positions. Alternatively, hiring manager 110, business unit manager 120, human resource manager 130, or recruiter 140 may trigger e-mail server 170 to forward notices to other members of community of position management 100 of a newly updated organization chart, or a new employment position that may be accessed using web server module 165.

Human resource record database 180 may be a computer system or software executed by a processor that is configured to store personnel records, organization charts, entries for changes made to the records, and other information used by members in community of position management 100. Position management architecture 105 may include one or more human resource record databases 180.

In one embodiment, human resource record database 180 may include position data records. A position data record may include basic position information such as pay grade, position number, position title, which organization a position belongs to, budget committed to a position, effective dates of a position, starting/terminating dates of a staff in the position, etc. A position data record may include information indicating the position's job status, such as whether the position is part time or full time, or/and, whether the position is current filled or vacant. A position data record may also include information indicating the position's legal status, such as whether the position is an employee position, a contractor position, an agent, etc. Further, a position data record may include information of other positions that are linked to the present position. For example, a position data record may include information indicating which position the present position reports to, and which positions report to the present position.

Position management system 190 may be a computer system or software executed by a processor that is configured to provide access to human resource records stored in a number of different formats, such as word processing format, spread sheet format, presentation format, etc. Position management system 190 may also permit the capture of organization structure change, by hosting a management process that facilitates the activities of members of community of position management 100.

In one embodiment, position management system 190 may generate organization charts based on position data records stored in human resource record database 180. For example, hiring manager 110 may request an organization chart displaying all positions in his current organization including employees, contractors, and agents. Position management system 190 may search human resource record database 180 to identify all position data records belonging to hiring manager 110's current organization. Referring back to the previous position data record example, each position data record may include information indicating which position the present position reports to, and which positions report to the present position. Position management system 190 may therefore generate an organization chart based on such logic links defining the reporting structure of all positions in the organization. Position management system 190 may also display in the organization chart, the legal status of a position, such as whether this position is for an employee, a contractor, or an agent, as defined in position data records.

In another embodiment, position management system 190 may generate reports upon requests from members of community of position management 100. For example, hiring manager 110 may request a report of all current positions in the organization, including filled and vacant positions, in relation to the budget information. Position management system 190 may search human resource record database 180 to identify all position data records belonging to hiring manager 110's current organization. Position management system 190 may also generate and present a report based on position data records stored in human resource record database 180, presenting the budget associated with all positions in the organization including vacant positions.

Another example of a report may be a position history report. Hiring manager 110 may request a report identifying staff members who have worked in a certain position for a certain time period. Position management system 190 may search human resource record database 180 to identify position data records corresponding to the specified position in hiring manager 110's organization in the inquired time period. Referring back to the previous position data record example, each position data record may include information indicating the effective date of a position, starting/terminating dates of a staff member. Position management system 190 may therefore generate and present a position history report based on position data records stored in human resource record database 180, presenting staff changes for a specific position in the certain time period.

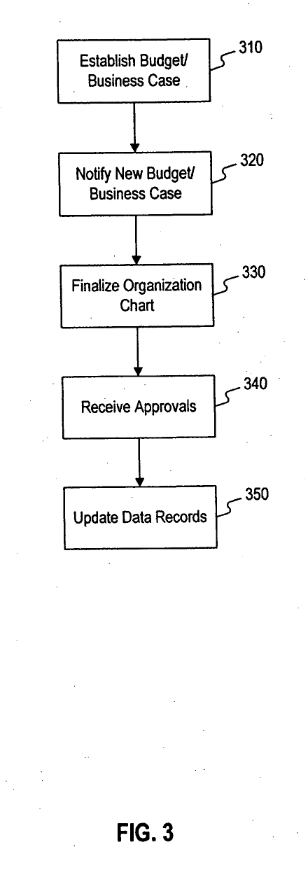

FIG. 3 illustrates an exemplary flow chart of a process for creating an organization chart. First, business unit manager 120 may use position management architecture 105 to establish a budget and a business case for a new organization, and to define positions needed for the organization according to the business case and budget (step 310). Business unit manager 120 may define the structure of a new organization chart for these positions. Business unit manager 120 may enter the business case information into position management system 190, associating the business case with the new organization chart.

A business case is a structured proposal for business improvement that often functions as a decision package for organizational decision-makers. A business case often includes an analysis of business process performance and associated needs or problems, proposed solutions, budget needs or budget commitment, and a risk-adjusted cost-benefit analysis. With respect to position management, a business case may specify positions that need to be filled to accomplish a project, how long each position is needed, budget committed, and the reporting structure of the defined positions. In the following descriptions, an organization chart is described in relation to its supporting business case. However, employment positions may be established and managed with or without a business case, and in other business contexts.

Human resource manager 130 may also review the business case and the related organization chart, and use position management architecture 105 to notify other members in community of position management 100 of the new business case and organization chart (step 320). Human resource manager 130 may use e-mail server 170 to send out notifications to other members in community of position management 100. Business unit manager 120 and/or hiring manager 110 may then further verify the positions requested by the business case in position management system 190.

Hiring manager 110, or human resource manager 130, may then review and finalize the organization chart in position management system 190 according to the verified business case, using position management architecture 105 (step 330). If business unit manager 120 did not create an organization with the business case in step 310, hiring manager 110 may create a new organization chart according to the new business case. Hiring manager 110 may also add, or delete a position in an existing organization chart in position management system 190. After an organization chart is finalized, human resource manager 130 may notify business unit manager 120, seeking final approval of the new organization chart.

After receiving notification for approval, business unit manager 120 may use position management system 190 to perform a final approval of the new organization chart related to the new budget/business case (step 340). Position management system 190 may receive the approval from business unit manager 120 and save the new organization chart in human resource record database 180.

Position management system 190 may also update position data records and other records as necessary to reflect this newly established organization chart (step 350). For example, position management system 190 may keep data records to facilitate the balanced scorecard methodology. The balanced scorecard methodology views the organization from four perspectives: the learning and growth perspective, the business process perspective, the customer perspective, and the financials perspective. The methodology promotes developing metrics, collecting data and analyzing data it relative to each of the four perspectives. With respect to position management architecture 105, to facilitate this methodology in an organization, position management system 190 may generate reports that accurately reflect the status of an organization. For example, a balanced scorecard report may report on positions added, deleted, approved, pending approval, vacant, and filled within certain time period. A balanced scorecard report may also include categories of the positions in an organization, such as management positions or contractor positions. A balanced scorecard report may reflect financial status of the positions such as whether a position is paid by salary or by hourly rate. A balanced scorecard report may also be used to measure staff member training and growth, or to analyze business processes.

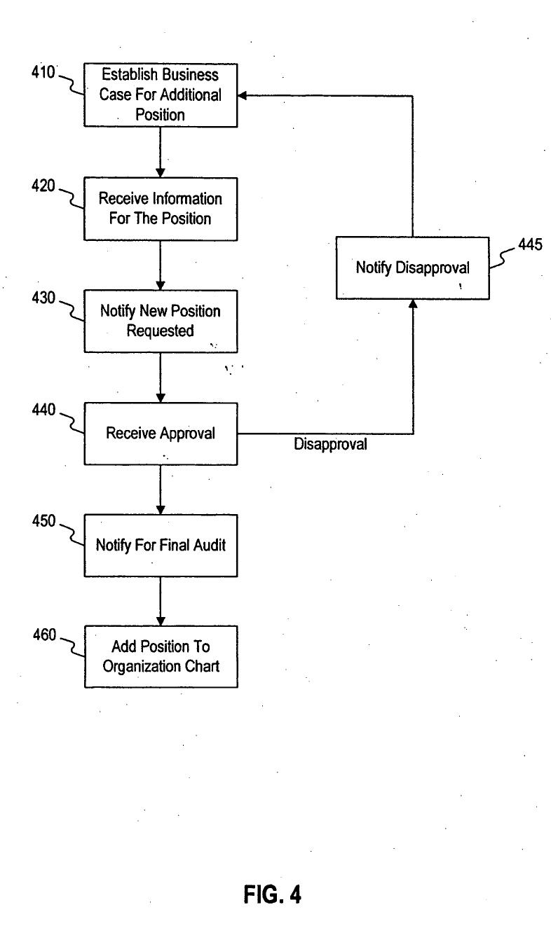

FIG. 4 illustrates a flow chart of an exemplary process for adding a position in an organization chart. Initially, hiring manager 110 may identify the need to add a position in addition to the current organization headcount. Hiring manager 110 may use position management system 190 to create a business case for this staff addition (step 410).

To provide more information regarding this position, hiring manager 110 may provide additional details for the position. In one embodiment, once hiring manager 110 indicates that a business case, such as “Add HR Personnel Assistant Position,” requires adding a new position, position management system 190 may then present an “Add” form. The “Add” form may include data entry fields such as the title, effective time, position code, and other requirement of the position. After hiring manager 110 fills in detailed information in the “Add” form, he may submit the form to position management system 190. Position management system 190 may then receive detailed position information submitted by hiring manager 110 (step 420). For example, hiring manager 110 may select the position number “1786” for position title “Personnel Assistant” in an “Add” form, and submit detailed position information to position management system 190. Hiring manager 110 may also specify positions directly reporting to position “Personnel Assistant,” and the position “Personnel Assistant” would report to.

Once position management system 110 receives the submission for adding a new position, it may invoke e-mail server 170 to send out a notification to business unit manager 120 regarding the new position (step 430). Hiring manager 110 or human resource manager 130 may also use e-mail server 170 to send out notifications about the new position.

After being notified about this new position, business unit manager 120 may then approve the business case for adding the new position in position management system 190. Position management system 190 may receive the final approval information (step 440).

If business unit manager 120 disapproves the business case to add the new position, position management system 190 may then send out a notification through e-mail server 170 to hiring manager 110 and human resource manager 130 notifying them about the disapproval (step 445). Position management system 190 may route back to step 410.

If business unit manager 120 approves the business case to add the new position in position management system 190, upon receiving the approval, position management system 190 may send the new position to human resource manager 130 for the final audit (step 450). For example, human resource manager 130 may verify whether business unit manager 120 has approved, or whether the added position is duplicated in another business case. After the audit, human resource manager 130 may approve the new position in position management 190.

When position management system 190 has received all necessary approvals and audits from members in community of position management 100, position management system 190 may add a vacant position to hiring manager 110's organization chart to reflect the newly added position (step 460). For example, position management system 190 may add the position numbered “Personnel Assistant” in the organization chart. At the same time, position management system 190 may update position data records and organization chart information to reflect the newly added position.

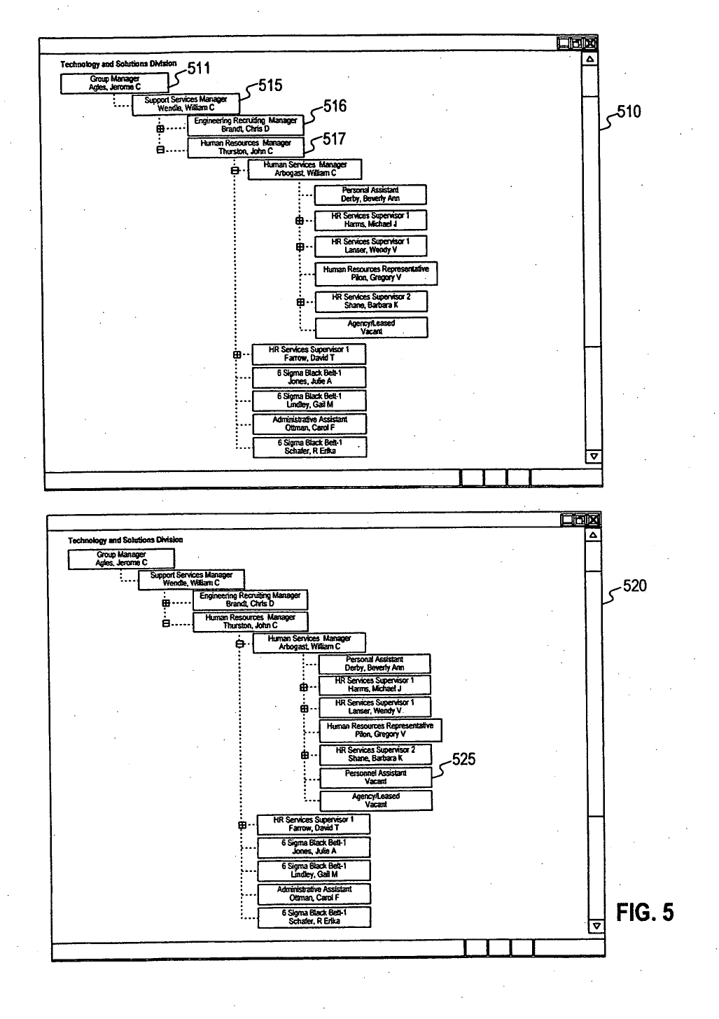

FIG. 5 provides two exemplary organization charts 510 and 520 that may be created, stored, and displayed by systems and methods consistent with the disclosed embodiments. Organization charts 510 and 520 may reflect organization structures before and after a process for adding a position as described in FIG. 4. Organization chart 510 may be an organization chart for the organization named “Technology and Solutions Division.” Hiring manager 110 for the technology and solution division may enter, in position management system 190, a new business case, “Add HR Personnel Assistant Position,” to add a new position “Personnel Assistant” to the organization. Hiring manager 110 may fill in detailed information in the “Add” form specifying that the “Personnel Assistant” would report to “Human Services Manager,” and no other positions would report to position “Personnel Assistant.” Hiring manager 110 may then submit the form to position management system 190. Position management system 190 may receive the detailed position information submitted by hiring manager 110, and subsequently invoke e-mail server 170 to send out a notification to business unit manager 120. If business unit manager 120 approves the business case to add the new position in the organization, position management system 190 may send the notifications for the new position to human resource manager 130 for a final audit. When position management system 190 receives all necessary approvals from members in community of position management 100, position management system 190 may add a vacant position 525 to hiring manager 110's organization chart 510 to reflect the newly added position. The new organization chart 520 may therefore reflect this newly added position, “Personnel Assistant.”

Further, FIG. 5 illustrates certain aspects of position data records stored in human resource record database 180, as described in FIG. 2 in relation to human resource record database 180. For example, the position data record for support services manager 515 may contain data indicating that position 515, support services manager, reports to position 511. Further, the position data record for support services manager 515 may indicate the positions reporting to position 515. That is, the position data record for position 515 may define that engineering recruiting manager 516 and human resources manager 517 report to position 515. Position management system 190 may utilize such logical links defined among positions within an organization to build an organization chart 510 showing all positions in an organization and the related reporting structure.

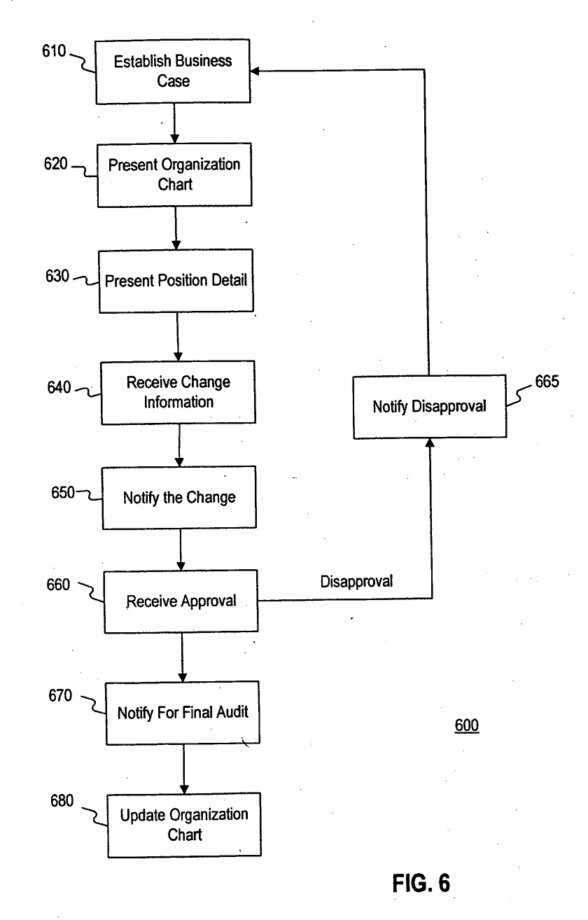

FIG. 6 illustrates a flow chart of an exemplary process for changing a position in an organization chart. The vacate process for vacating a position may be similar to changing a position in an organization chart. When a staff member is transferred out of an organization, retiring, or quitting, the staff's current position may be vacated to indicate future vacancy in the organization. Because of the similarities, process 600 may be generally referred to as either a vacate process or a process to change a position.

Hiring manager 110 may identify the need to change or vacate a position, such as the need to change a position from full time status to part time status in his organization. Hiring manager 110 may use position management system 190 to establish a business case for this position change (step 610).

Next, hiring manager 110 may select the organization chart containing the position needed to be changed or vacated. Position management system 190 may then present the selected organization chart to hiring manager 110 (step 620).

Hiring manager 110 may select, in the present organization chart, which position would be changed or vacated in position management system 190. Position management system 190 may then present detailed information about the selected position on a “Change” or “Vacate” form (step 630). Detailed information presented on this form may include full time/part time status of a position, salary grade of a position, and the like.

Hiring manager 110 may make the change to the position on this form. For example, hiring manager 110 may change the position from a full time position to a part time position. Hiring manager 110 may also vacate a position using this form. When vacating a position, hiring manager 110 may further define the date the position would be vacated, and whether a new hire would be needed to fill the vacated position in the future. Position management system 190 may receive this change information from hiring manager 110 (step 640).

Once position management system 190 receives the submission for changing the position, it may invoke e-mail server 170 to send out a notification to business unit manager 120 (step 650). Hiring manager 110 or human resource manager 130 may also use e-mail server 170 to send out notifications about the position change.

After being notified about this position change, business unit manager 120 may then approve the business case for changing the position in position management system 190. Position management system 190 may receive this approval information (step 660).

If business unit manager 120 disapproves the business case to change the status of the position in position management system 190, position management system 190 may then send out a notification through e-mail server 170 to hiring manager 110 and human resource manager 130, notifying them about the disapproval (step 665). Position management system 190 may then route back to step 610.

If business unit manager 120 approves the business case to change the position in position management system 190, upon receiving the approval, position management system 190 may send the position change to human resource manager 130 for a final audit (step 670). For example, human resource manager 130 may verify whether business unit manager 120 has approved changing the status of a position. After the audit, human resource manager 130 may approve the position change in position management system 190.

When position management system 190 has received all necessary approvals and audits from members in community of position management 100, position management system 190 may make a change to the position in hiring manager 110's organization chart to reflect the newly updated position (step 680). For example, position management system 190 may change the position numbered “1786” from full time status to part time status in the organization chart. When vacating a position, position management system 190 may show the position as vacant at a defined date according to the vacating request from hiring manager 110. Position management system 190 may update the position data records, and organization chart information to reflect the newly changed, or vacated position.

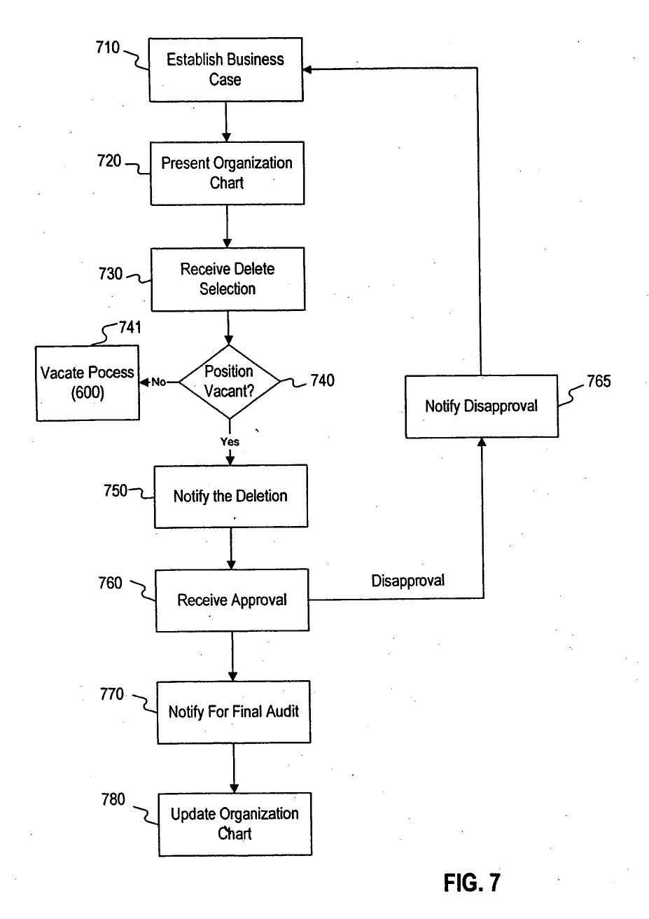

FIG. 7 illustrates a flow chart of an exemplary process for deleting a position in an organization chart. First, hiring manager 110 may identify the need to delete a position from the current organization. Hiring manager 110 may communicate the elimination of the position to business unit manager 120, and obtain authorization to delete the position. Hiring manager 110 may use position management system 190 to create a business case for this position deletion (step 710).

Next, hiring manager 110 may select the organization chart containing the position to be deleted. Position management system 190 may therefore present the selected organization chart to hiring manager 110 (step 720).

Hiring manager 110 may select, in the presented-organization chart, which position would be deleted using position management system 190. Position management system 190 may receive this selection of position deletion (step 730).

Position management system 190 may then check whether the position to be deleted is currently vacant (step 740). If the position is currently filled, position management system 190 may direct hiring manager 110 to vacate process 600, as described in FIG. 6 (step 741). Hiring manager 110 may start from step 610 to step through the whole process. Alternatively, hiring manager 110 may start from one of the interim steps, such as step 620, to complete the vacate process if the business case has already be created. If the position to be deleted is vacant, hiring manager 110 may delete the position. Position management system 190 may receive this deletion request from hiring manager 110.

Once position management system 190 receives the request to delete the position, it may invoke e-mail server 170 to send out a notification to business unit manager 120 (step 750). Hiring manager 110 or human resource manager 130 may also use e-mail server 170 to send out notifications about the position deletion.

After being notified about this position deletion, business unit manager 120 may then approve the business case for deleting the position in position management system 190. Position management system 190 may receive this approval information (step 760).

If business unit manager 120 disapproves the business case to delete the position in the organization, position management system 190 may then send out a notification through e-mail server 170 to hiring manager 110 and human resource manager 130 notifying them about the disapproval (step 765). Position management system 190 may then perform processes starting at step 710.

If business unit manager 120 approves the business case to delete the position in position management system 190, upon receiving the approval, position management system 190 may send the position deletion request to human resource manager 130 for the final audit (step 770). For example, human resource manager 130 may verify whether business unit manager 120 has approved the deletion. After the audit, human resource manager 130 may approve the position deletion in position management system 190.

When position management system 190 has received all necessary approvals and audits from members in community of position management 100, position management system 190 may delete the position in hiring manager 110's organization chart to reflect the deletion (step 780). Position management system 190 may update position data records and organization chart information to reflect the position deletion.

For example, referring back to FIG. 5, hiring manager 110 may request position 525 “Personnel Assistant” be deleted from his current organization as shown in organization chart 520. After all necessary approvals and audits, position management system 190 may delete position 525 from organization chart 520, and generate the updated organization chart 510.

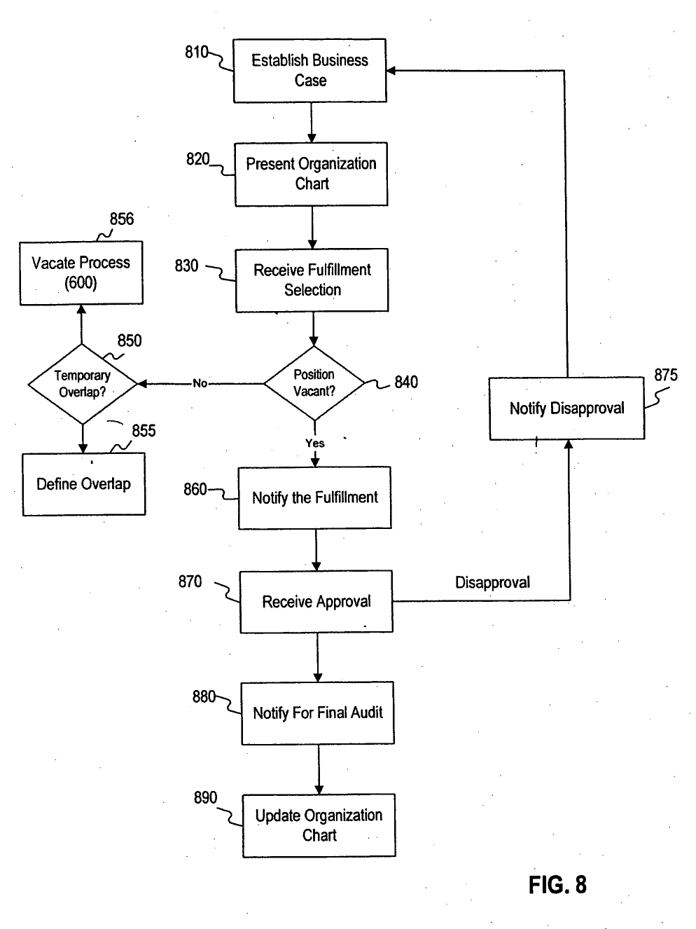

FIG. 8 illustrates a flow chart of an exemplary process for filling a position in an organization chart. Filling a position refers to the process of finding a candidate, and staffing a vacant position with the candidate. First, hiring manager 110 may identify the need to fill a position in the current organization. Hiring manager 110 may find a candidate by working with recruiter 140. Recruiter 140 may search within and outside the organization to help identify the candidate. Hiring manager 110 may send a request to fill a position to business unit manager 120, and obtain authorization to fill a position. Hiring manager 110 may use position management system 190 to create a business case for filling this position (step 810).

Next, hiring manager 110 may select the organization chart containing the position to be filled. In one embodiment, position management system 190 may therefore present the selected organization chart to hiring manager 110 (step 820).

Hiring manager 110 may use position management system 190 to select which position would be filled in the presented organization chart. Position management system 190 may then receive the selection of position to be filled (step 830).

Position management system 190 may then check whether the to be filled position is currently vacant (step 840). If the position is vacant, hiring manager 110 may fill in details including information such as job posting number, salary rates, and effective starting dates for the candidate to start at the position, etc. in position management system 190.

If the position is currently filled, position management system 190 may then provide hiring manager 10 with the option to overlap the incumbent staff member's termination date with the starting date of the candidate for the position (step 850).

Hiring manager 10 may then choose, in position management system 190, to overlap the starting/terminating dates for the incumbent staff member and the future staff member for the position. In one embodiment, position management system 190 may display a form for hiring manager 10 to define the overlap information for the position (step 855). For example, referring back to organization chart 510, hiring manager 110 may decide to fill position 515 with a new candidate named “Andrew, Andy” in the near future. Hiring manager 110 may decide that candidate “Andrew, Andy” would start on Jan. 10, 2006. Hiring manager 110 may further decide that the incumbent staff member “Wendle, William C” would terminate on Jan. 31, 2006. Hiring manager 110 may therefore define the overlap in position management system 190, by entering the termination date of the incumbent (Jan. 31, 2006) and the starting date of the new candidate (Jan. 10, 2006) of position 515.

Alternatively, instead of allowing overlap of the incumbent and the new staff member, hiring manager 110 may select to vacate the position before filling it. Position management system 190 may then perform vacate process 600, as described in FIG. 6 for hiring manager 110 (step 856). Hiring manager 110 may start from step 610 to step through the whole vacate process. Alternatively, hiring manager 110 may start from one of the interim steps, such as step 620, to complete the vacate process. After the position is vacated, hiring manager 110 may then fill the position.

If the to be filled position is vacant, once position management system 190 receives the request to fill the position, it may invoke e-mail server 170 to send a notification to business unit manager 120 about the fulfillment of the position (step 860). Hiring manager 110 or human resource manager 130 may also use e-mail server 170 to send out notifications about the position fulfillment.

After being notified about this position fulfillment, business unit manager 120 may then approve the business case for filling the position in position management system 190. Position management system 190 may receive this approval information (step 870).

If business unit manager 120 disapproves the business case to fill the position, position management system 190 may then send out a notification through e-mail server 170 to hiring manager 110 and human resource manager 130, notifying them about the disapproval (step 875). Position management system 190 may then perform the processes in connection with step 810.

If business unit manager 120 approves the business case to fill the position in position management system 190, upon receiving the approval, position management system 190 may send the position fulfillment request to human resource manager 130 for the final audit (step 880). For example, human resource manager 130 may verify whether business unit manager 120 has approved the fulfillment. After the audit, human resource manager 130 may approve the position fulfillment in position management system 190.

When position management system 190 has received all necessary approvals and audits from members in community of position management 100, position management system 190 may make change to the position in hiring manager 110's organization chart to reflect the new staff member who filled the position (step 890). When an incumbent's termination date and a future candidate's starting date overlaps, position management system 190 may display the overlap in hiring manager 110's organization chart during the overlap time period. Upon the incumbent's termination date, position management system 190 may automatically update the organization chart to reflect the incoming candidate as the only staff member in that position. Position management system 190 may update position data records and organization chart information to reflect the staff overlap, and a newly staffed position as necessary.

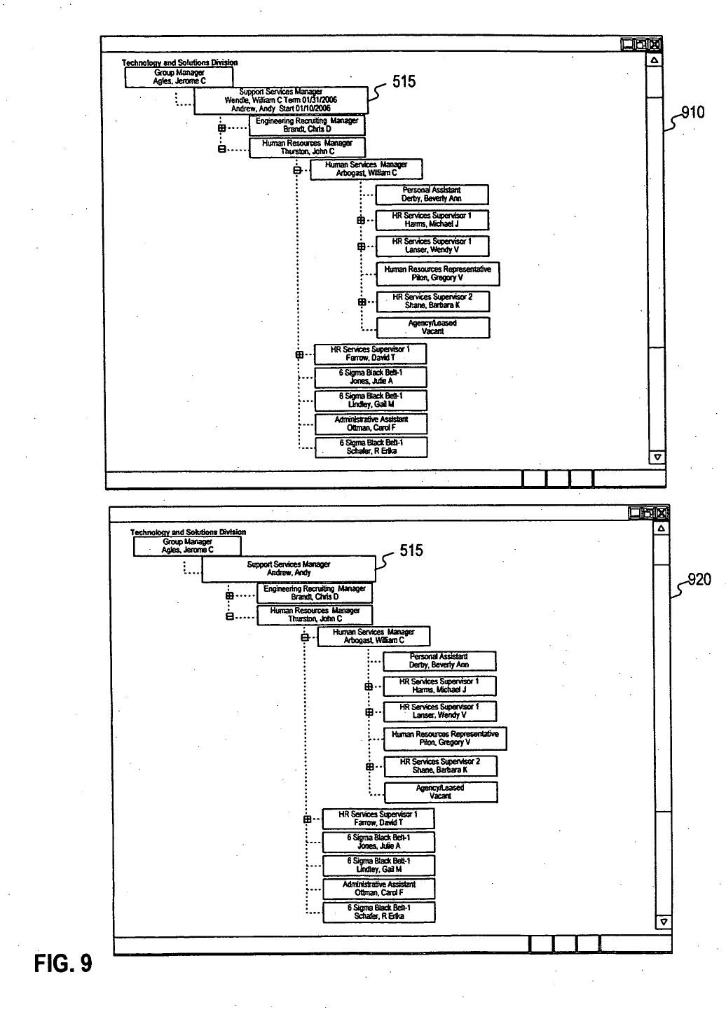

FIG. 9 provides two exemplary organization charts 910 and 920 to show the overlap time period of exemplary position 515. Referring back to the overlap date example described in relation to step 855. The overlap time period may be defined as after the incoming candidate's starting date (e.g. “Andrew, Andy” starts on Jan. 10, 2006), and before the termination date of the incumbent (e.g. “Wendle, William C” terminates on Jan. 31, 2006).

As shown in FIG. 9, during the overlap time period, position management system 190 may display a modified organization chart 910, showing position 515, “Support Service Manager,” with the overlap dates. Modified organization chart 910 may also be available for the period of time after hiring manager 110 entered the vacate/fill request, but before the starting date of the incoming candidate (e.g. “Andrew, Andy” starts on Jan. 10, 2006).

On the starting date of the incoming candidate (e.g. “Andrew, Andy” starts on Jan. 10, 2006), position management system 190 may update organization chart 910 to show that the incoming candidate has become the staff member for position 515 on the updated organization chart 920. Alternatively, on the termination date of the incumbent staff member (e.g. “Wendle, William C” terminates on Jan. 31, 2006), position management system 190 may update organization chart 910 to show, that the incoming candidate (e.g. “Andrew, Andy”) has become the only staff member for position 515 on the updated organization chart 920.

### INDUSTRIAL APPLICABILITY

Position management systems and methods consistent with the disclosed embodiments provide an organization a way to maintain a clear picture of the organization structure, and how budget and salary expenses attach to positions, whether a position is filled or vacant. The disclosed embodiments also support clear documentation of the addition or discontinuation of positions in an organization.

The disclosed embodiments may be applicable to monitor employee turnover and available budget resulting from vacancies. An organization may monitor budget by positions by using disclosed embodiments. The disclosed embodiments may also support aggregation to demonstrate savings realized by a vacant position in the organization's budget.

Further, the disclosed embodiments may aggregate reports on positions for one or multiple organizations to show staff movements. The embodiments may maintain accurate position records, such as historical records for positions showing previous staff members filling certain positions in an organization.

Moreover, the disclosed embodiments provide a “one stop shopping” process for hiring managers to keep track of their positions and budget via using organizational charts, and to plan future staffing needs in advance via allowing overlap staff members in a position so hiring managers may hire new staff members prior to the incumbent's leaving date.

It will be apparent to those skilled in the art that various modifications and variations can be made in the disclosed armature assembly without departing from the scope of the disclosure. Additionally, other embodiments of the disclosed system will be apparent to those skilled in the art from consideration of the specification. It is intended that the specification and examples be considered as exemplary only, with a true scope of the disclosure being indicated by the following claims and their equivalents.

What is claimed is:

1. A system for providing position management, comprising:
a community of position management including members; and
a position management system configured to:
create an organization chart with one or more employment positions associated with an organization,
receive a request to change an employment position in the organization,
notify one or more members in the community to approve the requested change, and
generate an updated organization chart reflecting the requested change of the employment position.

2. The system of claim 1, wherein the position management system is further configured to:
add an employment position to the organization chart in response to a request from a member of the community.

3. The system of claim 1, wherein the position management system is further configured to:
delete an employment position from the organization chart in response to a request from a member of the community.

4. The system of claim 1, wherein the position management system is further configured to:
vacate an employment position in the organization chart in response to a request from a member of the community.

5. The system of claim 1, wherein the position management system is further configured to:
present a legal status of an employment position in the organization chart.

6. The system of claim 1, wherein the position management system is further configured to:
fill an employment position in the organization chart in response to a request from a member of the community.

7. The system of claim 1, wherein the position management system is further configured to:
define an overlap of staff members in an employment position in the organization chart upon a request from a member of the community.

8. The system of claim 1, wherein the position management system is further configured to:
record effective dates of an employment position, and record starting and terminating dates of a staff member in the employment position.

9. A system for providing position management, comprising:
a community of position management including members; and
a position management system configured to:
create an organization chart with one or more employment positions associated with an organization,
receive a request to vacate an employment position in the organization chart,
notify one or more members in the community to approve the vacate request, and
generate an updated organization chart reflecting the vacate request of the employment position.

10. The system of claim 9, wherein the position management system is further configured to:
present a vacant employment position in the organization chart upon a request from a member of the community.

11. The system of claim 9, wherein the position management system is further configured to:
record an effective date to vacate the employment position on the organization chart.

12. The system of claim 11, wherein the effective date to vacate the employment position is the termination date of an incumbent employee associated with the employment position upon a request from a member of the community.

13. The system of claim 11, wherein the effective date to vacate the position is the starting date of an incoming candidate associated with the employment position upon a request from a member of the community.

14. The system of claim 11, wherein the position management system is further configured to:
automatically update the organization chart at the recorded effective date.

15. A method for position management in a community of position management including members; and a position management system, the method performed by the position management system comprising:
creating an organization chart with one or more employment positions associated with an organization,
receiving a request to change an employment position in an organization,
notifying one or more members in the community to approve the requested change, and
generating an updated organization chart reflecting the requested change of the employment position.

16. The method of claim 15, further including:
adding an employment position to the organization chart in response to a request from a member of the community.

17. The method of claim 15, further including:
deleting an employment position from the organization chart in response to a request from a member of the community.

18. The method of claim 15, further including:
vacating an employment position in the organization chart in response to a request from a member of the community.

19. The method of claim 15, further including:
presenting a legal status of an employment position in the organization chart in response to a request from a member of the community.

20. The method of claim 15, further including:
filling an employment position in the organization chart in response to a request from a member of the community.

21. The method of claim 15, further including:
allowing overlap of staff members in an employment position in the organization chart upon a request from a member of the community.

22. The method of claim 15, further including:
recording effective dates of an employment position, and starting and terminating dates of a staff member in the position.

23. A method for position management in a community of position management including members, and a position management system, the method performed by the position management system comprising:
creating an organization chart with one or more positions associated with an organization,
receiving a request to vacate a position in the organization chart,
notifying one or more members in the community to approve the vacate request, and
generating an updated organization chart reflecting the requested vacating of the employment position.

24. The method of claim 23, further including:
presenting a vacant employment position in the organization chart in response to a request from a member of the community.

25. The method of claim 23, further including:
recording an effective date to vacate the employment position.

26. The method of claim 25, further including:
updating the organization chart at the recorded effective date automatically.

27. A system for providing position management, comprising:
a recruitment module identifying a candidate to fill an employment position;
a human management module verifying and approving a position management request; and
a position management module configured to:
create an organization chart with one or more employment positions associated with an organization,
receive the position management request to fill the employment position in the organization,
notify one or more members in the community to approve the requested fulfillment, and
generate an updated organization chart reflecting the requested fulfillment of the employment position.

28. The system of claim 27, wherein the position management module is further configured to:
delete an employment position from the organization chart in response to a request from a member of the community of position management.

29. The system of claim 27, wherein the position management module is further configured to:
vacate an employment position in the organization chart in response to a request from a member of the community of position management.

30. The system of claim 27, wherein the position management module is further configured to:
present a legal status of an employment position in the organization chart in response to a request from a member of the community of position management.

31. The system of claim 27, wherein the position management module is further configured to:
define an overlap of staff members in the employment position in the organization chart.

32. The system of claim 27, wherein the position management module is further configured to:
record starting and terminating dates of a staff member in the employment position.
